(19) United States
(12) Patent Application Publication
(10) Pub. No.: US 2008/0047387 A1
(43) Pub. Date: Feb. 28, 2008

(54) Automatic transmission control device select by knob rotation

(75) Inventor: Jonathan P. Sussman, Farmington Hills, MI (US)

Correspondence Address: YOUNG & BASILE, P.C., 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 11/501,293

(22) Filed: Aug. 9, 2006

(51) Int. Cl. G05G 1/04

(52) U.S. Cl. 74/523

(57) ABSTRACT

A shift lock device for controlling transmission gear changes with an automatic transmission shift lever can include an elongate shaft and a twist-lock release mechanism. The elongate shaft can define at least a portion of an automatic transmission shift lever. The elongate shaft can be arcuately pivotable about a transverse axis with respect to a longitudinal axis of the elongate shaft for changing transmission gears. The twist lock-release mechanism can be pivotable about the longitudinally extending axis of the elongate shaft for releasing the shift lever from an arcuate pivotal position associated with at least one transmission-gear-select position. A biasing member can urge the twist lock release mechanism toward a locked position for releasibly retaining the shift lever in an arcuate pivotal position associated with at least one transmission-gear-select position. Rotation of the knob can move a shift-lever-lock member between a locked position and a released position.

### FIELD OF THE INVENTION

The present invention relates to a shift lock device for controlling automatic transmission gear changes with an automatic transmission shift lever having a twist lock release mechanism rotatable about a longitudinally extending axis of an elongate shaft for releasing the shift lever from an arcuate pivotal position associated with at least one transmission-gear-select position.

### BACKGROUND

Various automatic transmission safety shift lock devices are known to those skilled in the art. For example, vehicle gear shift lever locking devices are disclosed in U.S. Pat. No. 4,671,085; U.S. Pat. No. 5,431,267; U.S. Pat. No. 6,575,049; and U.S. Pat. No. 5,016,738. The automatic gear shift lever locking devices typically operate in response to interaction with an ignition key lock and/or brake pedal depression and/or push button actuation in order to operably move the locking member from a locked position to a released position allowing movement of the automatic transmission gear shift lever between a park position and a plurality of drive positions.

### SUMMARY

A shift lock device for controlling transmission gear changes with an automatic transmission shift lever can include an elongate shaft defining at least a portion of an automatic transmission shift lever, where the elongate shaft is arcuately pivotable about a transverse axis with respect to a longitudinal axis of the elongate shaft for changing transmission gears. A twist lock-release mechanism can rotate about a longitudinal extending axis of the elongate shaft for releasing the shift lever from an arcuate pivotable position associated with at least one transmission-gear-select position.

A shift lock device for controlling transmission gear changes with an automatic transmission shift lever can include an elongate shaft defining at least a portion of an automatic transmission shift lever, where the elongate shift lever has a longitudinally extending axis and is rotatable about the longitudinal axis between a first angular position and a second angular position of rotational movement. The elongate shaft can be arcuately pivotable about a transverse axis with respect to the longitudinal axis of the elongate shaft for changing transmission gears with the shift lever. A cam surface associated with the elongate shaft rotates and pivots in response to rotating and pivoting movement of the elongate shaft. A cam follower movable between a locked position and a released position operates in response to interaction with a cam surface as the elongate shaft rotates about the longitudinal axis between the first angular position and the second angular position of rotational movement.

A shift lock device for controlling transmission gear changes with an automatic transmission shift lever can include an elongate shaft defining at least a portion of an automatic transmission shift lever. The elongate shaft can be rotatable about a longitudinal axis between a first angular position and a second angular position of rotational movement. The elongate shaft can arcuately pivot about a transverse axis with respect to the longitudinal axis of the elongate shaft for changing transmission gears with the shift lever. A biasing member can urge the elongate shaft in a rotational direction about the longitudinal axis toward the first angular position of rotational movement. A cam surface associated with the elongate shaft rotates and pivots in conjunction with movement of the elongate shaft. A cam follower can move between a locked position and a released position in response to interaction with a cam surface as the elongate shaft rotates about the longitudinal axis between the first angular position and the second angular position of rotational movement. A biasing member can urge the cam follower toward the locked position. A detent pattern can include a detent corresponding with a transmission gear select position of the shift lever for each gear of the transmission and can be operably engaged by a portion of the cam follower for releasibly holding the shift lever in an arcuate pivotal select position of the shift lever associated with at least one transmission-gear-select position.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a front elevational view of a shift lock device for controlling transmission gear changes with an automatic transmission shift lever according to an embodiment of the present invention;

FIG. 2 is a side elevational detail of the shift lock device illustrated in FIG. 1 illustrating arcuately pivotable movement about a transverse axis with respect to a longitudinal axis of the elongate shaft for changing transmission gears with the shift lever and a detent pattern having a detent corresponding with a transmission gear select position of the shift lever of each gear of the transmission;

FIG. 3 is a detailed front elevational view of another embodiment of a cam surface and cam follower combination for a shift lock device;

FIG. 4 is a detailed front elevational view of another embodiment of a cam surface and cam follower combination for shift lock device; and

FIG. 5 is a detailed front elevational view of another embodiment of a cam and cam follower combination for a shift lock device.

### DETAILED DESCRIPTION

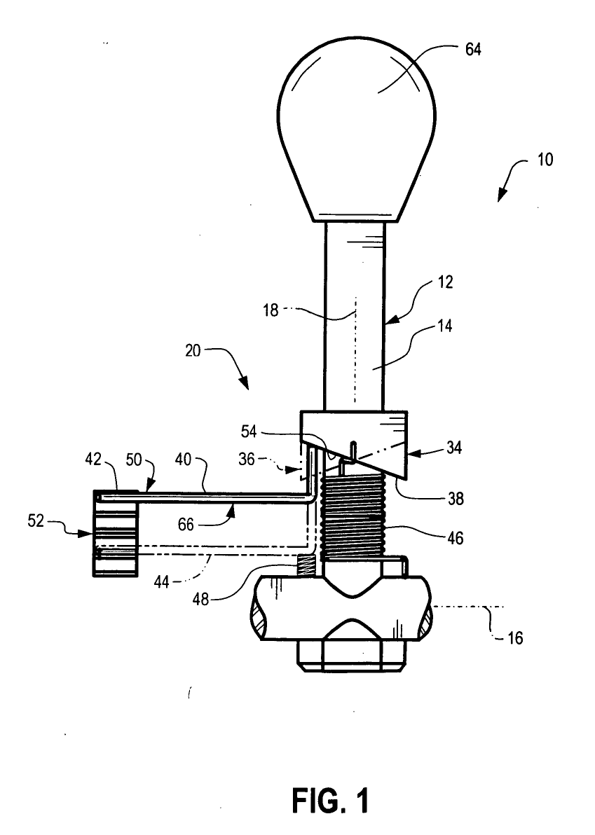

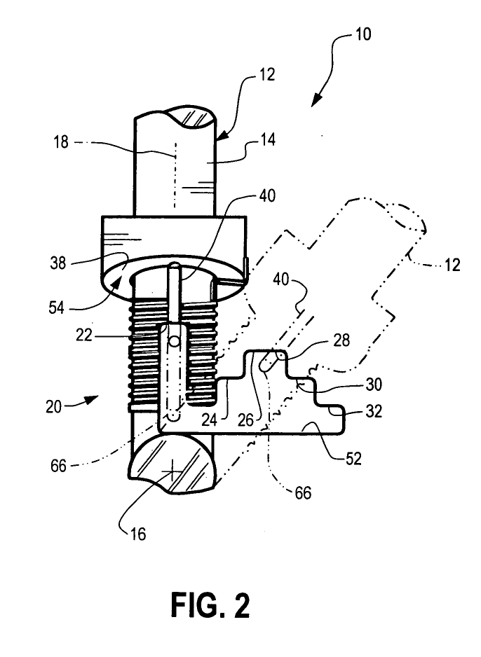

Referring now to FIGS. 1 and 2 a shift lock device 10 is illustrated for controlling transmission gear changes with an automatic transmission shift lever 12 according to an embodiment of the present invention. An elongate shaft 14 can define at least a portion of an automatic transmission lever 12. The elongate shaft 14 can arcuately pivot about a transverse axis 16 with respect to a longitudinal axis 18 of the elongate shaft 14 for changing transmission gears. A twist lock-release mechanism 20 rotates about the longitudinally extending axis 18 of the elongate shaft 14 for releasing the shift lever 12 from an arcuate pivotal position associated with at least one transmission-gear-select position, by way of example and not limitation, a reverse position 24, a neutral position 26, a drive position 28, a second gear position 30, a first gear position 32, and/or an overdrive position (not shown) as best seen in FIG. 2.

The elongate shaft 14 can be rotatable about the longitudinal axis 18 between a first angular position 34 and a second angular position 36 of rotational movement. The twist lock-release mechanism 20 can include a cam surface 38 associated with the elongate shaft 14 for rotating and pivoting movement with the elongate shaft 14, and a cam follower 40 movable between a locked position 42 and a released position 44 in response to interaction with the cam surface 38 as the elongate shaft 14 rotates about the longitudinal axis 18 between the first angular position 34 and the second angular position 36. A first biasing member 46 can urge the elongate shaft 14 in a rotational direction about the longitudinal axis 18 toward the first angular position 34 of rotational movement. A second biasing member 48 can urge the cam follower 40 toward the locked position 42.

A lock member portion 50 associated with the cam follower 40 can operably engage with a detent pattern 52 having a detent corresponding with each transmission gear of the automatic transmission (i.e. park position 22, reverse position 24, neutral position 26, drive position 28, second gear position 30, first gear position 32, and/or overdrive position). The lock member portion 50 can releasibly hold the shift lever 12 in an arcuate pivotal position of the shift lever 12 associated with at least one transmission-gear select position. As is conventional, certain gear select movements can be provided without requiring a twisting lock-release movement of the shift lever, by way of example and not limitation, movement from the reverse position to the neutral position, movement from the neutral position to the drive position, movement from the first gear position to the second gear position, and movement from second gear position to the drive position, or any combination thereof as desired. The operation of the shift lever 12 requiring a twisting lock-release movement to move the shift lever 12 between the park position and any other transmission-gear-select position can be controlled by the configuration of the detent pattern 52. It should also be apparent that movement into the park position 22 from any other transmission-gear-select position would also require twisting lock-release movement of the shift lever as illustrated in FIGS. 1 and 2, and as best seen in FIG. 2. Other configurations of the detent pattern 52 can be provided as required for the desired operation of the lock-release mechanism 20. The lock member portion 50 in cooperation with the detent pattern 52 can releasibly hold shift lever 12 in an arcuate pivotal position of the shift lever 12 associated with at least one transmission-gear-select position until the lock member portion 50 has been removed from the corresponding detent of the detent pattern 52. If desired, the lock member portion 50 in cooperation with the detent pattern 52 can allow the shift lever 12 to be moved to another adjacent transmission-gear-select position while the cam follower 40 is in the locked position 42.

A knob 64 attached to a longitudinal end of the shift lever 12 can be grasped by a vehicle operator for rotational movement about the longitudinal axis 18 to move a shift-lever-lock member 66, by way of example and not limitation such as cam follower 40, between a locked position 42 and a released position 44. A first biasing member 46 can urge the twist lock-release mechanism 20 toward a locked position 42 for releasibly retaining a shift lever 12 in an arcuate pivotal position associated with at least one transmission-gear-select position, by way of example and not limitation, such as a park position 22, a reverse position 24, a neutral position 26, a drive position 28, a second gear position 30, a first gear position 32, and/or an overdrive position. A cam surface 38 can be movable in response to rotation of the knob 64 about the longitudinal axis of the elongate shaft 14 for moving a shift-lever-lock member 66 between the lock position 42 and the release position 44. A second biasing member 48 can urge the shift-lever-lock member 66 toward the locked position 42.

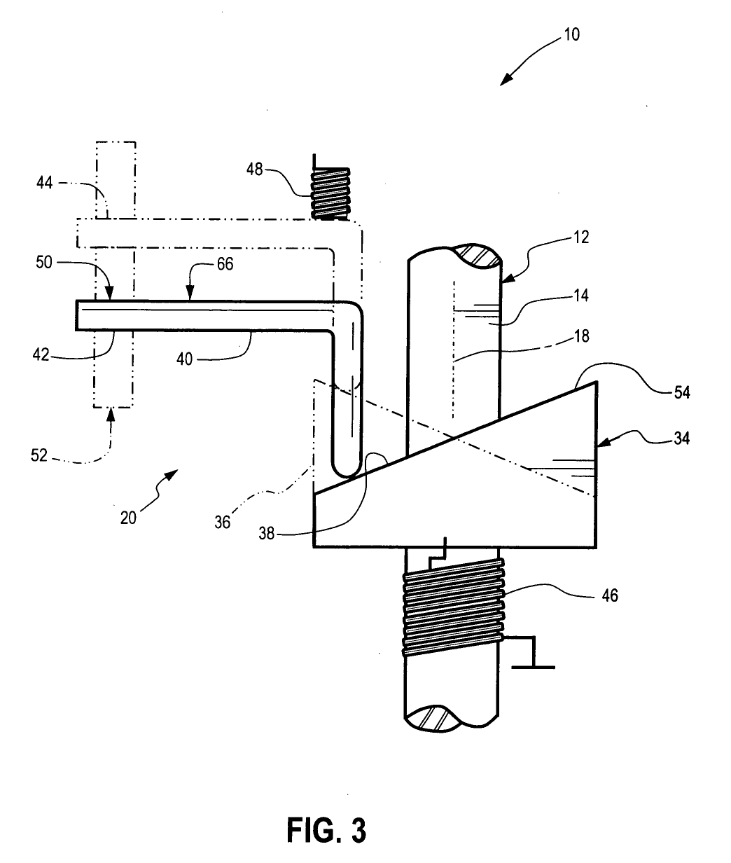

Referring now to FIG. 3, another embodiment of a shift lock device 10 according to the present invention is illustrated with the cam surface 38 formed on a transversely extending surface 54 with respect to the longitudinal axis 18 of the elongate shaft 14. The cam surface 38 is illustrated on an upper surface of the shaft 14 in FIG. 3, while previously being illustrated on a lower surface of the shaft 14 in FIGS. 1 and 2. The cam follower 40 is illustrated repositioned for operable engagement with the cam surface 38. It should be noted that the cam follower 40 in either embodiment can be any structural configuration and is not limited to an L-shaped configuration as illustrated schematically in FIGS. 1-2 or FIG. 3. The other aspects of operation of the shift lock device 10 illustrated in FIG. 3 are the same as described with respect to FIGS. 1-2.

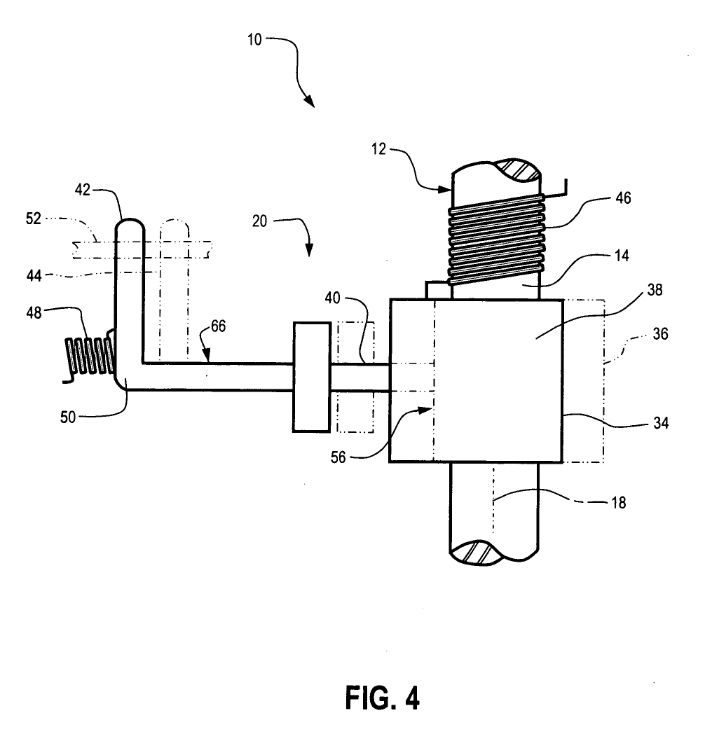

Referring now to FIG. 4, another embodiment of a shift lock device is illustrated having a cam surface 38 defined by a longitudinally extending surface 56 with respect to longitudinal axis 18 of the elongate shaft 14. The cam surface 38 can be in the form of a lobe, ellipse, oval, cylinder with a flat, or like structure providing a surface with a radially varying dimension for driving the cam follower. In this configuration, the second biasing member 48 urges the cam follower 40 toward the longitudinally extending cam surface 38, 56. Rotation of the elongate shaft 14 causes rotation of the cam surface 38 allowing the cam follower 40 to move from the locked position 42 to the released position 44. The other aspects of the operation of the shift lock device 10, are the same as described for the embodiment illustrated in FIGS. 1-2.

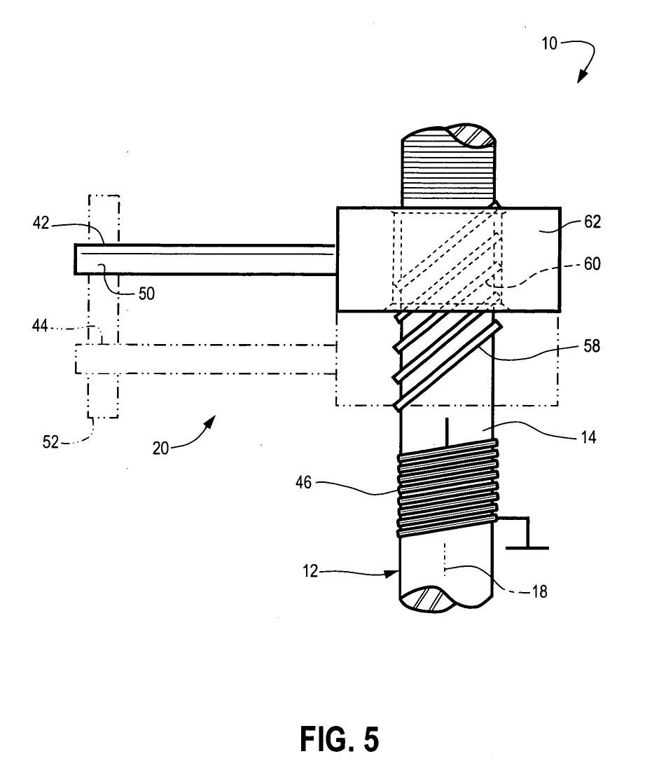

Referring now to FIG. 5, another embodiment of a shift lock device 10 is illustrated including a cam surface 38 defined by a helical thread surface 58 extending along a longitudinally extending periphery or circumference of the elongate shaft 14, and a cam follower 40 defined by a corresponding helical threaded aperture 60 formed in reciprocal member 62 for longitudinal movement in response to rotation of the elongate shaft 14. The other aspects of operation of the shift lock device 10, are the same as described with respect to the embodiment illustrated in FIGS. 1-2.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A shift lock device for controlling transmission gear changes with an automatic transmission shift lever comprising:
an elongate shaft defining at least a portion of an automatic transmission shift lever, the elongate shaft having a longitudinally extending axis and being rotatable about the longitudinal axis between a first angular position and a second angular position of rotational movement, the elongate shaft arcuately pivotable about a transverse axis with respect to the longitudinal axis of the elongate shaft for changing transmission gears with the shift lever;
a cam surface associated with the elongate shaft for rotating and pivoting movement with the elongate shaft; and
a cam follower movable between a locked position and a released position in response to interaction with the cam surface as the elongate shaft rotates about the longitudinal axis between the first angular position and the second angular position of rotational movement.

2. The shift lock device of claim 1 further comprising:
a biasing member urging the elongate shaft in a rotational direction about the longitudinal axis toward the first angular position of rotational movement.

3. The shift lock device of claim 1 further comprising:
a biasing member urging the cam follower toward the locked position.

4. The shift lock device of claim 1 further comprising:
a lock member portion associated with the cam follower; and
a detent pattern having a detent corresponding with each transmission gear of the automatic transmission and to be operably engaged by the lock member portion of the cam follower for releasibly holding the shift lever in an arcuate pivotal position of the shift lever associated with at least one transmission-gear-select position.

5. The shift lock device of claim 4, wherein the lock member portion in cooperation with the detent pattern, releasibly holds the shift lever in an arcuate pivotal position of the shift lever associated with at least one transmission-gear-select position until the lock member portion has been removed from the corresponding detent.

6. The shift lock device of claim 4, wherein the lock member portion, in cooperation with the detent pattern, releasibly holds the shift lever in an arcuate pivotal position associated with at least one transmission-gear-select position, while allowing the shift lever to be moved to another adjacent transmission-gear-select position while the cam follower is in the locked position.

7. The shift lock device of claim 1, wherein the cam surface is defined by a transversely extending surface with respect to the longitudinal axis of the elongate shaft.

8. The shift lock device of claim 1, wherein the cam surface is defined by a longitudinally extending surface with respect to the longitudinal axis of the elongate shaft.

9. The shift lock device of claim 1, wherein the cam surface is defined by a helical thread surface extending along a longitudinally extending circumference of the elongate shaft, and the cam follower is defined by a reciprocal member having a corresponding helical threaded aperture for longitudinal movement in response to rotation of the elongate shaft.

10. A shift lock device for controlling transmission gear changes with an automatic transmission shift lever comprising:
an elongate shaft defining at least a portion of an automatic transmission shift lever, the elongate shaft having a longitudinally extending axis and being rotatable about the longitudinal axis between a first angular position and a second angular position of rotational movement, the elongate shaft arcuately pivotable about a transverse axis with respect to the longitudinal axis of the elongate shaft for changing transmission gears with the shift lever;
a biasing member urging the elongate shaft in a rotational direction about the longitudinal axis toward the first angular position of rotational movement;
a cam surface associated with the elongate shaft for rotating and pivoting movement with the elongate shaft;
a cam follower movable between a locked position and a released position in response to interaction with the cam surface as the elongate shaft rotates about the longitudinal axis between the first angular position and the second angular position of rotational movement;
a biasing member urging the cam follower toward the locked position; and
a detent pattern having a detent corresponding with a transmission gear select position of the shift lever for each gear of the transmission and to be operably engaged by a portion of the cam follower for releasibly holding the shift lever in an arcuate pivotal select position of the shift lever associated with at least one transmission-gear-select position.

11. The shift lock device of claim 10, wherein the portion of the cam follower, in cooperation with the detent pattern, releasibly holds the shift lever in an arcuate pivotal position associated with at least one transmission-gear-select position until the portion of the cam follower has been removed from the corresponding detent.

12. The shift lock device of claim 10, wherein the portion of the cam follower, in cooperation with the detent pattern, releasibly holds the shift lever in an arcuate pivotal position of the shift lever associated with at least one transmission-gear-select position, while allowing the portion of the shift lever to be moved to another adjacent transmission-gear-select position while the cam follower is in the locked position.

13. The shift lock device of claim 10, wherein the cam surface is defined by a transversely extending surface with respect to the longitudinal axis of the elongate shaft.

14. The shift lock device of claim 10, wherein the cam surface is defined by a longitudinally extending surface with respect to the longitudinal axis of the elongate shaft.

15. The shift lock device of claim 10, wherein the cam surface is defined by a helical thread surface extending along a longitudinally extending circumference of the elongate shaft, and the cam follower is defined by a reciprocal member having a corresponding helical threaded aperture for longitudinal movement in response to rotation of the elongate shaft.

16. A shift lock device for controlling transmission gear changes with an automatic transmission shift lever comprising:
an elongate shaft defining at least a portion of an automatic transmission shift lever, the elongate shaft arcuately pivotable about a transverse axis with respect to a longitudinal axis of the elongate shaft for changing transmission gears; and
a twist lock-release mechanism rotatable about the longitudinally extending axis of the elongate shaft for releasing the shift lever from an arcuate pivotal position associated with a currently engaged, transmission-gear-select position.

17. The shift lock device of claim 16, wherein the twist lock-release mechanism further comprises:
a knob attached to a longitudinal end of the shift lever for rotation about the longitudinal axis to move a shift-lever-lock member between a locked position and a released position.

18. The shift lock device of claim 16, wherein the twist lock-release mechanism further comprises:
a biasing member urging the twist lock release mechanism toward a locked position for releasibly retaining the shift lever in an arcuate pivotal position associated with a currently engaged, transmission-gear-select position

19. The shift lock device of claim 16, wherein the twist lock-release mechanism further comprises:
a cam surface moveable in response to rotation of the knob about the longitudinal axis of the elongate shaft for moving a shift-lever-lock member between a locked position and a released position.

20. The shift lock device of claim 19, wherein the twist lock-release mechanism further comprises:
a biasing member urging the shift-lever-lock member toward the locked position.
